(19) United States
(12) Patent Application Publication
(10) Pub. No.: US 2026/0359375 A1
(43) Pub. Date: Nov. 12, 2026

(54) Web Browsing Search Enhancements

(71) Applicant: PayPal, Inc., San Jose, CA (US)

(72) Inventor: Faizul Islam Mohammed, Hayward, CA (US)

(21) Appl. No.: 19/201,635

(22) Filed: May 7, 2025

(51) Int. Cl. G06F 16/957; G06F 16/9538; G06F 16/955; G06F 21/62

(52) U.S. Cl. CPC G06F 16/9577; G06F 16/9538; G06F 16/9562; G06F 21/6227

(57) ABSTRACT

Disclosed methods and systems include executing, by a computer system, instructions of a browser extension to perform a search query to identify particular information included within two or more selected tabs of a web browser. Selected tabs may include information retrieved from one or more servers. Performing the search query may include searching a first portion of memory storing data for a first selected tab for the particular information and searching a second portion of memory storing data for a second selected tab for the particular information. Methods may further include aggregating identified information resulting from the search query, including filtering the results into ones of a plurality of categories. The computer system may generate a user interface for the aggregated information, including an interface to select one of the plurality of categories to display, and display a subset of the aggregated information related to the selected category.

### BACKGROUND

### Technical Field

This disclosure relates generally to searching online content, and more particularly to techniques for enhancing performance and management of web browser information searches.

### Description of the Related Art

Professionals, especially in complex environments, may work across numerous open tabs in a web browser, gathering and referencing content from multiple sources like documents, meeting transcripts, project pages, and online sites. A particular challenge is efficiently locating specific information across these tabs without manually switching between them, remembering content locations, and struggling to identify search terms that provide desired results. Traditional search tools don't support a cohesive natural language understanding across multiple tabs and often fall short in providing context-based responses, leading to time-consuming and fragmented workflows.

Additionally, there may be a desire to retain, bookmark, and organize content for quick reference at a later point in time. However, accessing video transcripts and other restricted content can be challenging, as they're often limited to specific users, or are isolated in individual applications. Due to security and privacy restrictions, this type of content may be restricted from storage external from their native applications and/or databases. Access to such content may, however, be valuable for local use in future projects and for enhanced search capabilities across related resources. A problem lies in the lack of a secure, streamlined way to save, search, and reference such diverse, restricted content locally across various software tools.

### BRIEF DESCRIPTION OF THE DRAWINGS

FIG. 1 is a block diagram illustrating an embodiment of a system that may be used to perform an enhanced search using the disclosed techniques.

FIG. 2 shows a block diagram of an embodiment of a system that may be used to perform an enhanced search using a locally generated server.

FIG. 3 depicts a block diagram of another embodiment of a system that may be used to perform an enhanced search using aa locally generated server.

FIG. 4 illustrates a block diagram of an embodiment of a system that may be used to perform an enhanced search of video content using the disclosed techniques.

FIG. 5 shows a flow diagram of an embodiment of a method for performing an enhanced search across a plurality of browser tabs.

FIG. 6 depicts a flow diagram of an embodiment of a method for performing an enhanced search of secure content using a locally generated server.

FIG. 7 illustrates a flow diagram of an embodiment of a method for generating a searchable local server to access and manage secure content.

FIG. 8 is a block diagram illustrating an example computer system, according to some embodiments.

### DETAILED DESCRIPTION

As disclosed above, a user may desire to search for content across a plurality of open tabs in a web browser. In some cases, content in one or more of the open tabs may have restricted access, e.g., requiring the user to enter credentials for authorization to access this content. Search tools typically search in a single open tab for a given search query. Tools for searching across the plurality of open tabs with a single search query are desired. In addition, techniques are desired for managing access to secure content that may be included within one or more of the open tabs. The user may further desire to organize and save (e.g., via bookmarks) particular ones of any generated search results.

The present disclosure recognizes that a novel search tool may be implemented that supports applying a given search query across a number of open tabs in a concurrent fashion. Such a tool may include a capability to provide credentials to authorize access to secure content. Results from the given search query may be filtered, organized and presented to a user based on context of the search term(s) and/or other input from the user. An ability to save results in a manner that allows the user to access the content at a later point in time may also be included.

Disclosed embodiments include a technique in which a computer system may execute instructions of a browser extension to perform a search query to identify particular information included within two or more selected tabs of a web browser. The selected tabs may include respective information retrieved from one or more servers. Performing the search query may include searching in a first portion of memory storing data for a first selected tab for the particular information and searching in a second portion of memory storing data for a second selected tab for the particular information. The computer system may then aggregate identified information resulting from the search query, including filtering the results into ones of a plurality of categories. The computer system may also generate a user interface for the aggregated information, including an interface to select one of the plurality of categories to display. The user interface may also display a subset of the aggregated information related to the selected category.

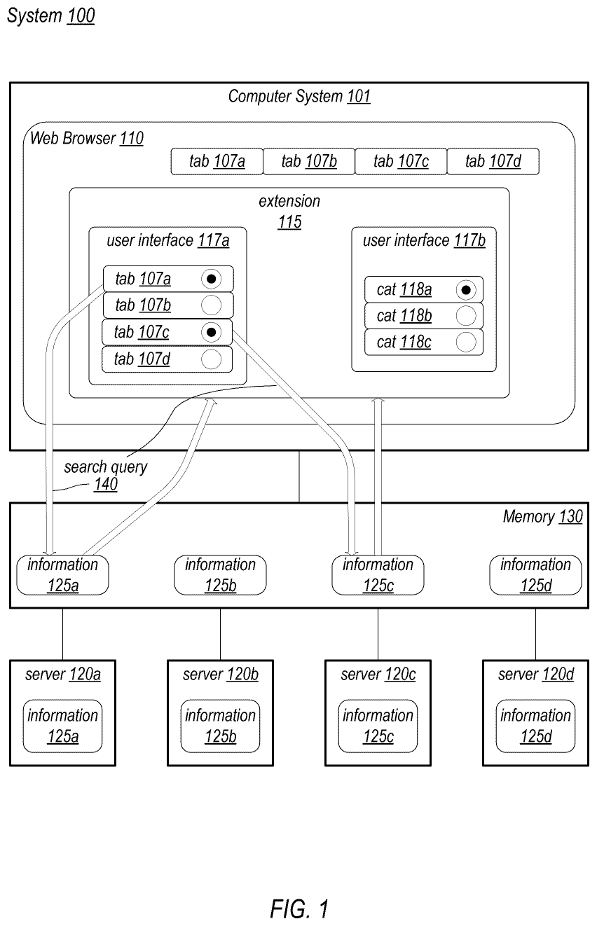

A block diagram of an embodiment of a system that may be used to implement the disclosed techniques is illustrated in FIG. 1. As illustrated, elements of system 100 include computer system 101, memory 130, and a plurality of servers 120a-120d (collectively 120). Computer system 101, in various embodiments, may be implemented as a single computer (e.g., a desktop computer, laptop computer, server computer), or a plurality of computers located in a single location or distributed across multiple locations. In some embodiments, computer system 101 may be implemented using a virtual machine hosted by one or more server computer systems. In various embodiments, memory 130 may be included as a part of computer system 101 or may be an external memory system implemented as an individual mass-storage device, a plurality of storage devices operating as a single storage device, one or more storage devices managed by a virtual computer, or other suitable type of storage system. Each of servers 120 may be implemented in a similar manner as computer system 101 and/or memory 130. Computer system 101, in various embodiments, may be coupled directly to servers 120, linked to servers 120 via a local area network (LAN), linked to servers 120 via a wide area network (e.g., the internet), or a combination thereof.

As illustrated, computer system 101 may be configured to execute instructions of web browser 110, within which, four tabs 107a-107d are shown as being open. Tabs 107 may correspond to respective web pages and are associated with information 125a-125d (collectively tabs 125), which has been sent from servers 120a-120d, respectively, to memory 130. Information 125 may include any data associated with the web pages in tabs 107, including web page information, documents and other content that are displayed or linked to in the web pages, scripts being executed in the web pages, and the like. For example, tab 107a may include a web page for viewing a particular video file and may further include links to other video files, text information for closed captions for the video file, and other similar information. Tab 107c may correspond to a cloud computing application being used to edit one or more documents and may also include links to other documents associated with the cloud application.

Computer system 101 may be further configured to execute instructions of browser extension 115 that is configured to provide additional functionality to web browser 110. Web browser 110 may be any commercially available browser application capable of supporting extensions (also commonly referred to as add-ons, browser apps, and the like). In other embodiments, extension 115 may be implemented as a separate application from web browser 110 while retaining a capability to cause web browser 110 to perform the actions described below.

Computer system 101 may, as shown, be configured to use extension 115 to perform a search query to identify particular information included within retrieved information 125 associated with two or more selected tabs of tabs 107 within web browser 110. To perform search query 140, extension 115 generates user interface 117a to indicate, to a user of computer system 101, available ones of tabs 107 that are available for searching. As depicted, user interface 117a indicates that each of tabs 107a-107d are available to search and an open circle is displayed by each tab 107 for the user to select the corresponding tab 107. Tabs 107a and 107c are selected, as indicated by the dots within their respective circles, although any other suitable technique for selecting options from a list may be utilized. Extension 115 may receive indications that tabs 107a and 107c have been selected. As described above, tabs 107a and 107c include respective information 125a and 125c that have been retrieved from servers 120a and 120c, respectively.

As illustrated, extension 115 may be configured to generate search query 140 which may then be initiated to search retrieved information 125a and 125c corresponding to tabs 107a and 107c to identify information relevant to the particular information included in search query 140. For example, the video file playing in tab 107a may be a recording of a meeting in which various topics were discussed, and tab 107c may include one or more documents that were shown or discussed in the meeting. The particular information of search query 140 may be related to one of these topics. Extension 115 may initiate a search in a first portion of memory 130 that is storing data for tab 107a (e.g., a portion of memory storing information 125a) for the particular information. Similarly, extension 115 may initiate a search in a second portion of memory 130 that is storing data for tab 107c (e.g., a portion of memory storing information 125c) for the particular information. It is noted that the searches in the first and second portions of memory 130 may be performed concurrently, thereby reducing an amount of time to perform the searches across two different tabs of web browser 110.

Results from search query 140 may be received by extension 115, as shown. Extension 115 may aggregate identified information resulting from search query 140, e.g., results from information 125a may be combined with results from information 125c. Aggregating the identified information may include pre-processing the identified information to remove extraneous information. For example, the identified information may include a particular document that includes various metadata, such as author, date created, date last modified, a company associated with the author, file size, and the like. Some, or all, of such metadata may be removed to reduce an amount of data being processed. In some embodiments, language used by the user to generate the search query, or other options indicated by the user, may be used to determine what data may be removed and what data is kept. For example, the author and last modification date may be retained while the remaining data is removed.

Extension 115 may then filter the identified information from tabs 107a and 107c into ones of a plurality of categories 118a-118c (collectively 118). Categories 118 may correspond to types of information identified, such as letters, memos, email, videos, audio files, pictures, hypertext markup language (HTML), and so forth. In some embodiments, categories 118 may correspond to different levels of detail of the identified information, including a summary category that includes a least number of details, and an insights category that includes a greatest number of details. For example, a summary category may display only a name of an identified file, while an insights category may include several lines of text extracted from the identified file that are determined to be most relevant to search query 140. In some embodiments, multiple levels of categories may be included, allowing a user to select, for example, a detail level as well as a type of information to display.

As shown, extension 115 may be further configured to generate user interface 117b for the filtered information. User interface 117b may include options to select a particular one of categories 118 to display. As depicted, user interface displays the three categories 118, including circles for the user to click to select the corresponding category 118 to display. The user may select one or (in some embodiments) more of categories 118 to display. The selected category 118a may, for example, correspond to a summary category. After the selection is received by user interface 117b, extension 115 may display, in user interface 117b, a subset of the filtered information included in the selected category 118a. The user may have further options to select a particular one or more search results from the subset of the filtered information, and/or to adjust the displayed information by selecting a different one of categories 118. The user may further be allowed to bookmark and/or save one or more of the search results for later use.

In some embodiments, the user may enter a natural language query string into a text box in user interface 117a. In such an embodiment, extension 115 may include one or more machine-learning models to interpret the user input and generate a suitable set of search terms to generate search query 140. Actions taken by the user in response to the displayed search results may be further used to train the one or more machine-learning models. For example, particular files that are bookmarked and/or saved by the user may be used to train the machine-learning models with successful results while results that are not accessed may be used to train the machine-learning models with unsuccessful results. The user actions may further be used to train models used to aggregate and filter the identified information received from search query 140.

Use of such techniques may reduce complexity of performing searches across a plurality of browser tabs. The reduced complexity, in turn, may improve worker productivity as well as reduce processing time of computing equipment in system 100 by performing searches across the selected tabs concurrently rather than serially. Organization, filtering, and saving search results may further improve utilization of computing equipment by combining similar results and maintaining records of the results to reduce a need to repeat, at a later date, the search query.

It is noted that the embodiment of FIG. 1 is merely an example. Features of the system have been simplified for clarity. In other embodiments, additional elements may be included, such as networking circuits to couple servers 120 to computer system 101. As shown, each browser tab 107 is associated with a different server 120. In other embodiments, two or more tabs may retrieve data from a same server. In some embodiments, one tab 107 may retrieve data from a plurality of servers. Extension 115 may, in some embodiments, be implemented as a non-transitory computer-readable medium having instructions stored thereon that are executable by a computing device (e.g., computer system 101) to perform the disclosed operations.

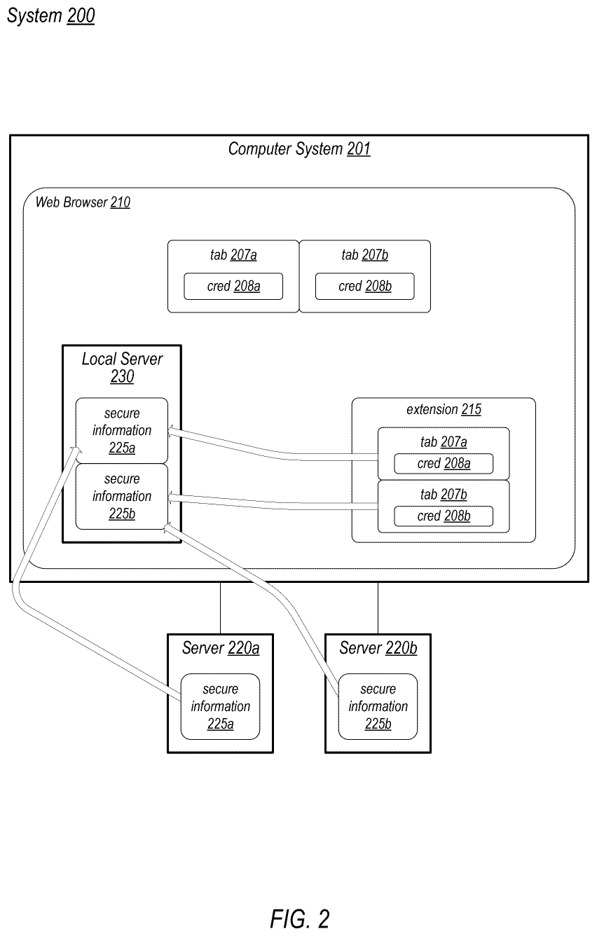

In the embodiment of FIG. 1, techniques for searching across a plurality of open tabs in a web browser are disclosed. It is possible for content that is accessible via a web browser to have restricted access. It may be desirable, in some cases, to include such restricted content within a search query. Accordingly, techniques for accessing information with restricted access are contemplated. An example of such a technique is depicted in FIG. 2.

Proceeding to FIG. 2, a system for searching secure information included in a plurality of servers is shown. As illustrated, system 200 includes computer system 201 and servers 220a and 220b (collectively 220). Similar to computer system 101 in FIG. 1, computer system 201 is configured to execute instructions to perform operations of web browser 210, including operations related to tabs 207a and 207b (collectively 207). Computer system 201 further configured to execute instructions to perform operations of extension 215, that provides additional features to web browser 210. Online servers 220a and 220b store respective secure information 225a and 225b (collectively 225) that are accessible to computer system 201 after credentials (cred) 208a and 208b, respectively, are validated via web browser 210.

As shown, computer system 201 may be configured to perform the operation of web browser 210 to generate tab 207a which retrieves information from server 220a, including secure information 225a. Web browser 210 may be configured to extract at least a portion of secure information 225a from online server 220a. To access secure information 225a, a request for credentials is displayed in tab 207a. A user of computer system 201 may then enter credentials 208a for accessing secure information 225a, which may than be received in tab 207a of web browser 210. To generate tab 207b, web browser 210 may be similarly configured to extract a portion of secure information 225b from online server 220b. As described for retrieving secure information 225a, web browser 210 may display a request to the user to enter credentials associated with secure information 225b. Accordingly, credentials 208b for accessing secure information 225b may be received in tab 207b of web browser 210.

Extension 215, as illustrated, may be configured to detect the use of credentials 208 for retrieving secure information 225. Based on this detection, extension 215 may create local server 230a on computer system 201. Local server 230 may be created in memory circuits included within computer system 201 or, in other embodiments, may be created in memory circuits coupled to, and accessible by, computer system 201. Extension 215 may be further configured to store the respective portions of secure information 225a and 225b in local server 230 using security protocols related to servers 220a and 220b, respectively. For example, secure information 225a in server 220a may include information that is required to be encrypted using one of one or more particular encryption algorithms. Secure information 225b in server 220b may include information that is required to be password protected but may not require encryption. In some embodiments, extension 215 may be configured to store the local portion of secure information 225a using a same encryption algorithm as used in server 220a and to store the local portion of secure information 225b using a same password as used in server 220b. In other embodiments, extension 215 may be configured to store both local portions of secure information 225 using a stricter one of the different security requirements or a combination of the different security requirements.

As illustrated, extension 215 may be configured to perform a search query to identify particular information included within tabs 207. Performing the search query may include extension 215 receiving, from a user interface, respective indications that tabs 207a and 207b have been selected. For example, extension 215 may be configured to display an activation button within web browser 210. In response to the user of computer system 201 activating this button, extension 215 may cause a new tab or a pop-up window to appear on a display of computer system 201 in which the user interface is rendered. Within the user interface, the user may be prompted to select one or more tabs to search, as well as the particular information to search. After tabs 207a and 207b have been selected, extension 215 may be configured to determine that these tabs include secure information 225 and, therefore, require authorization prior to searching. Accordingly, extension 215 may be configured to request, via the user interface, the user to enter credentials 208a and 208b. In other embodiments, extension 215 may determine that tabs 207a and 207b have already been verified and may be capable of reusing credentials 208a and 208b from the open tabs without requesting the user to re-enter the credentials. After receiving credentials 208a and 208b, extension 215 may be configured to verify credentials 208a and 208b with local server 230.

After receiving indications that credentials 208a and 208b have be validated by local server 230, extension 215 may be configured to search local server 230 to identify the portions of secure information 225a and 225b relevant to the particular information. Resulting matches may then be indicated to extension 215 and metadata associated with the results may be sent to extension 215. Extension 215 may then display, in the user interface, the metadata relevant to the identified portions of secure information 225a and 225b. In some embodiments, the relevant metadata may be displayed in a plurality of formats, selectable by the user within the user interface. For example, levels of detail may be a selectable option, allowing the user to decide how much information to display for each result. In addition, or in place of a level of detail, the user may have an option to select one or more types of results to display, such as text files, media files, spreadsheets, and the like.

Extension 215 may be further configured to organize, within local server 230 based on indications from the user interface, the respective portions of secure information 225a and 225b. For example, the organizing may include aggregating the identified portions of secure information 225a with the identified portions of secure information 225b and then filtering the aggregated portions into ones of a plurality of categories. Furthermore, the user may be able to select, via the user interface, particular ones of the results, or particular filters for saving results to local server 230, including an option to retain all information currently included in local server 230. Once the selections are submitted by the user, extension 215 may store, within local server 230, the organized portions of secure information 225a and 225b for subsequent search queries.

By generating local server 230, the secure information 225 from servers 220 may be searched without requiring extension 215 to access the servers. The option to store filtered results may further enable the user to share data with other authorized users who have valid credentials. In some embodiments, local server 230 may store information, including metadata associated with the stored results, which does not require valid credentials, thereby allowing the user to share the unsecure metadata results with other users who do not have valid credentials.

It is noted that the embodiment of FIG. 2 is merely an example. Although only two tabs associated with two respective servers are shown, any suitable number of tabs and servers may be included in other embodiments. In the illustrated embodiment, the disclosed techniques are described as being implemented by an extension application added to a web browser. It is contemplated that, in other embodiments, an independent application may implement the described techniques for searching for content across one or more other applications. For example, an independent application may be used to initiate a search across an active email application and/or an active media player.

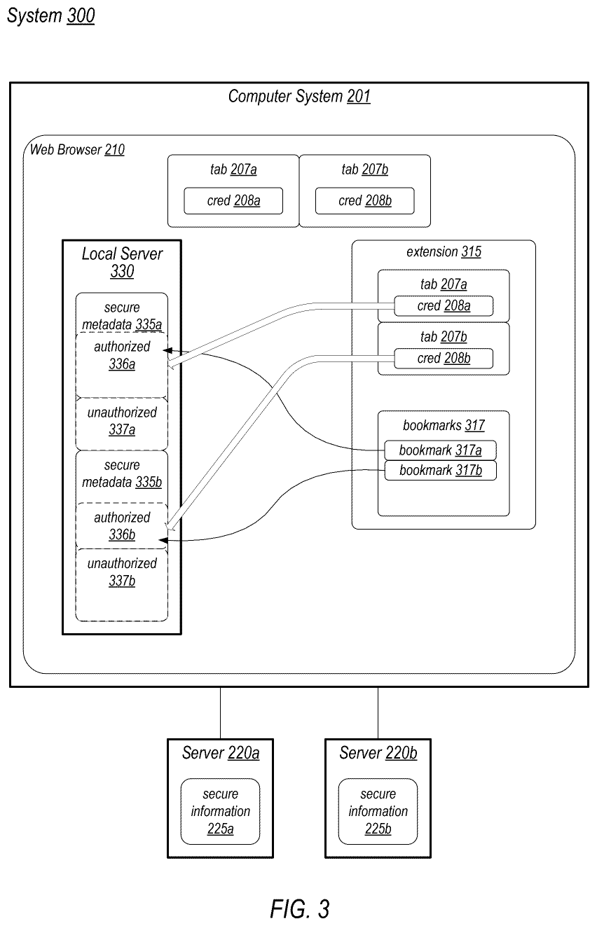

In FIG. 2, a technique is described for generating a local server for storing secure information from one or more servers. In some embodiments, it may not be desirable to copy secure information into such a local server. In addition, information stored within the local server may not be authorized for access to all potential users of the local server. An example of a computer system in which metadata is stored and organized in a local server is depicted in FIG. 3.

Moving to FIG. 3, a block diagram of an embodiment of a system that generates a local server to store metadata associated with secure information is shown. System 300 is shown with Computer system 201 and servers 220a and 220b from FIG. 2. As described above in regard to FIG. 2, computer system 201 is configured to execute instructions to perform operations of web browser 210, as well as extension 315 which provides additional features to web browser 210. Computer system 201 is coupled to online servers 220a and 220b. Servers 220a and 220b store respective secure information 225a and 225b that are accessible to computer system 201 after credentials (cred) 208a and 208b, respectively, are validated.

As described above, computer system 201 may be configured to execute instructions to perform operations of web browser 210, including accessing content, from servers 220a and 220b, to be presented in tabs 207a and 207b. In response to determining that secure information 225a and 225b are included in tabs 207 of web browser 210, extension 315 may be configured to create local server 330 on computer system 201. Extension 315 may be further configured to store secure metadata 335a and 335b that is indicative of secure information 225a and 225b, respectively. Secure metadata 335a and 335b, in some embodiments, may not directly include sensitive data, but may instead include links, tags, and/or other information associated with secure information 225a and 225b. Secure metadata 335a and 335b may, themselves, be allowed to be stored without security provisions. In other embodiments, however, to store secure metadata 335a and 335b in local server 330, extension 315 may be configured to use security protocols related to secure information 225a and/or 225b.

In some embodiments, local server 330 may be created in response to submitting credentials 208a and 208b to servers 220a and 220b, to generate tabs 207a and 207b, respectively. In such an embodiment, extension 315 may be configured to generate local server 330 prior to receiving a search query from a user. In other embodiments, however, extension 315 may generate local server 330 after receiving an initial search query that includes tab 207a and/or 207b.

Similar to the description above for FIG. 2, extension 315 is configured to populate local server 330 with secure metadata 335a and 335b that are associated with secure information 225a and 225b, respectively. Secure metadata 335 may be used in place of secure information 225 as a technique for increasing security of secure information 225a and 225b. In some embodiments, secure information 225a and/or 225b may include information that is restricted from being copied without particular security protocols in place. Accordingly, use of secure metadata 335 may allow references and/or other related information about secure information 225 to be stored outside of servers 220 without a requirement to satisfy the particular security protocols. Secure metadata 335 may provide adequate information about secure information 225 for performing searches by the user and enabling sharing of secure metadata 335 with others without violating the particular security protocols. For example, secure metadata 335 may include a link to a particular secure file along with associated tags that identify a topic, an author, and a project name of the particular file. While the content of the file may include secure information that is subject to be stored per the particular security protocols, secure metadata 335, itself, may not be subject to these protocols.

As shown, extension 315 may enable, via the stored secure metadata 335 in local server 330, bookmarking of secure information 225 within web browser 210. For example, extension 315 may enable the user to save bookmark 317a, using the organized portions of secure metadata 335, an associated item in secure information 225a. Bookmark 317a may not violate security protocols that are in place for the particular item. The user, upon selecting bookmark 317a, may be required to submit credentials 208a in order to access content of the particular item.

In some embodiments, local server 330 may include authorization levels for individual ones, or subsets, of secure metadata 335. When a given user submits a search query that includes information stored in local server 330, extension 315 may request that the user provides appropriate credentials for accessing secure information 225. For example, a first user, using credentials 208, may be logged into computer system 201 when local server 330 is generated. The first user may then share results with one or more associates. The first user and the associates may, individually, be assigned a respective authorization level of a plurality of levels. A second user, from the associates, may then submit a search query that includes searching local server 330, and extension 315 may request that the second user provide credentials for accessing servers 220. Accordingly, extension 315 may determine that the second user's verified credentials are valid for a subset of secure information 225. In response to this determination, extension 315 may be configured to perform the search query on the subset of the secure information (e.g., authorized secure metadata 336a and 336b), and omit portions of the secure information that are excluded from the subset (e.g., unauthorized secure metadata 337a and 337b). Authorized secure metadata 336a and 336b may include links to associated portions of secure information 225a and 225b in servers 220a and 220b that are authorized for the second user's credentials. Restricted portions of secure information 225 may be omitted from the search query.

By utilizing secure metadata 335 in local server 330 in place of secure information 225, security protocols may be maintained while allowing a user to organize, bookmark, and share search results with colleagues who may have different authorization levels for accessing secure information 225. Additionally, including tags that may provide descriptions, or other relevant information about secure information 225, in secure metadata 335 may enable users to gather sufficient details without having to access servers 220 as frequently. Reducing a number of accesses to secure information 225 may reduce traffic to servers 220 as well as reducing opportunities for secure information 225 being exposed to unauthorized users.

It is noted that FIG. 3 is one example of a computer system capable of using secure metadata to generate a local, searchable server. Although a particular number of tabs and servers are illustrated in FIG. 3, any suitable number of tabs and servers may be included in other embodiments. A single local server 330 is included in system 300. In other embodiments, however, more than one local server may be generated. For example, a respective local server may be generated for each server being searched that includes secure information.

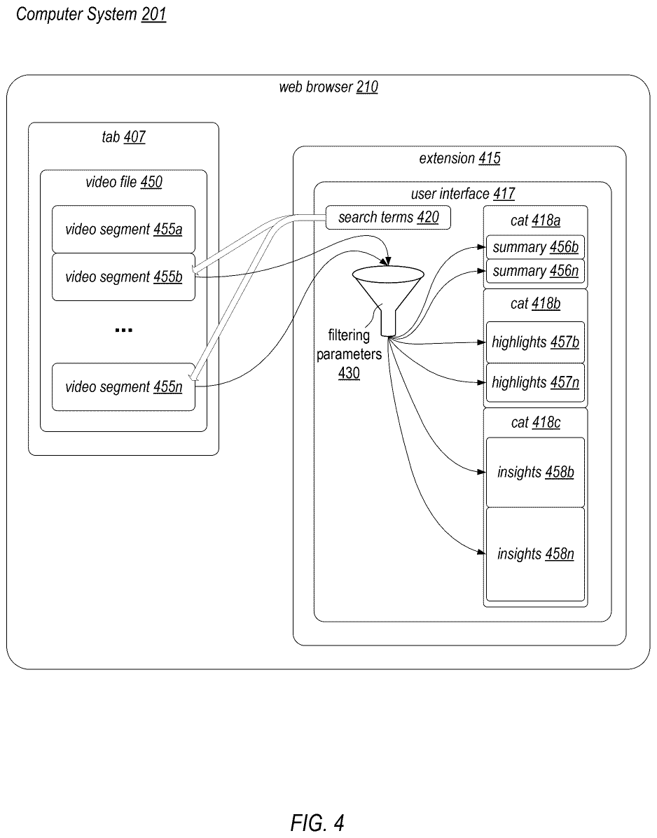

In the embodiments of FIGS. 1-3 disclose searching information associated with selected tabs for various types of information. One type of information that may be searched is media files. FIG. 4 depicts a computer system configured to search, using disclosed techniques, a video file that is included in a selected tab.

Proceeding to FIG. 4, a block diagram of another embodiment of a computer system is illustrated. Computer system 201 is shown, as above, executing instructions of web browser 210. Extension 415 has been added to web browser 210 to increase search capabilities. As shown, web browser 210 includes open tab 407 which, in turn, includes video file 450. Video file 450 is comprised of a series of video segments 455a-455n (collectively 455).

As illustrated, extension 415 includes user interface 417 in which an option to perform a search query is presented to a user of computer system 201. After selecting this search query option, the user may be prompted to enter one or more search terms 420, as well as to select one or more available tabs in which to perform the search query. In the present example, tab 407 is selected, thereby including video file 450 amongst data to be searched. Accordingly, performing the search query may include identifying portions (e.g., ones of segments 455) of video file 450 that correspond to the provided search terms 420.

Video segments 455 may be searched in a variety of manners. For example, a text-based caption file (e.g., a Web Video Text Track (vtt) or SubRip Text (srt)) may be included with video file 450 and a text search of the caption file may be searched for search terms 420. Identified matches in the caption file may return timestamp references to video file 450 and/or to a corresponding one of video segments 455. In other embodiments, audio portions of video file 450 may be converted to text using, for example, any suitable speech-to-text algorithm. Text shown in video, e.g., a slide or other document presented in a video conference, or hand-written text captured from a whiteboard, or the like may also be converted to searchable text and used to perform the search query.

In the illustrated example, search terms 420 result in matches in video segments 455b and 455n. As disclosed above, extension 415 may aggregate these identified portions of video file 450 with identified portions from other search matches in other tabs selected for the search query. Extension 415 may further filter the aggregated portions into ones of a plurality of categories (e.g., categories 418a-418c, collectively 418). In the illustrated embodiment, categories 418 correspond to different levels of detail of the identified information, including a summary category 418a that includes summaries 456b and 456n that have a least number of details for corresponding video segments 455b and 455n, respectively. Insights category 418c includes insights 458b and 458n that include a greatest number of details for respective video segments 455b and 455n. In between the summary and insights is a highlights category 418b includes highlights 457b and 457n for respective video segments 455b and 455n.

To filter the aggregated portions of the search results, extension 415 may be further configured to receive from user interface 417, one or more filtering parameters 430. These filtering parameters may indicate a date range for when respective video segments 455 were created or modified, may indicate a particular person or persons in video file 450, may narrow search terms 420 into particular topics discussed, and the like. Extension 415 may be further configured to filter the aggregated portions based on the one or more filtering parameters 430.

After search results have been aggregated, filtered, and categorized, the user may utilize user interface 417 to provide an indication of a detail level for displaying information. Extension 415 may then use the indicated detail level to determine a type of metadata to display for ones of the identified portions. For example, user interface 417 may include clickable buttons for selecting one of categories 418 in order to display the associated search summaries, highlights, and/or insights.

It is noted that the example of FIG. 4 is merely for demonstrative purposes. For clarity, only elements for illustrating the disclosed concepts are shown. Although a single tab with a respective video file is depicted, any suitable number of tabs may be open and selectable for a requested search query. Three categories are used in the present embodiment, but any reasonable number of categories may be used for filtering the search results. Other embodiments may include various other elements such as one or more servers. It is contemplated that the techniques of FIG. 4 may be combined with any of the techniques described for FIGS. 1-3.

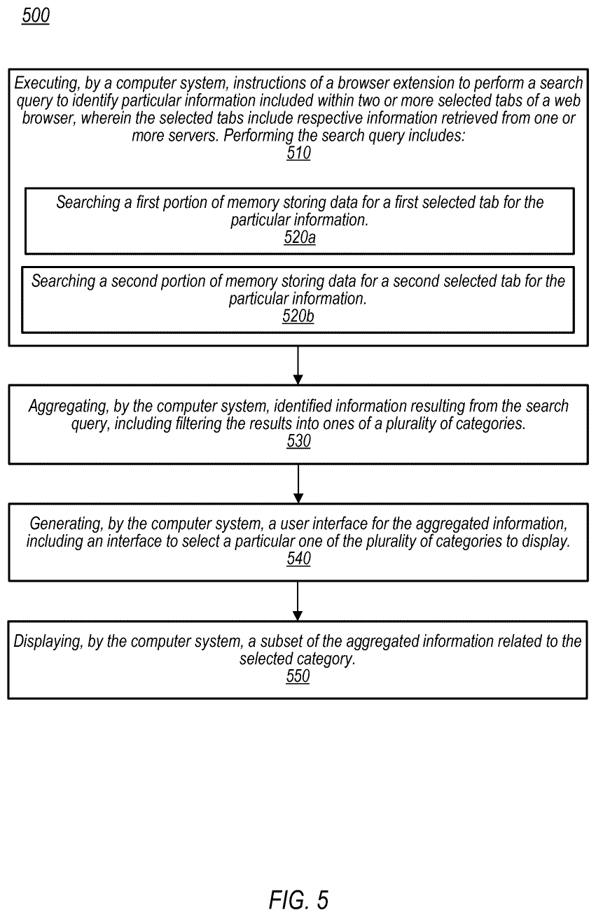

FIGS. 1-4 depict various systems for adding search capabilities to a web browser or other types of applications. These various systems may employ a variety of methods for implementing these capabilities. For example, computer systems 101 and 201 may include or be coupled to a non-transitory computer-readable medium that has instructions stored thereon that are executable by computer systems 101 and/or 201 to perform the operations described herein. The following FIGS. 5-7 illustrate examples of such methods.

Moving now to FIG. 5, a flow diagram of an embodiment of a method for initiating a search query across a plurality of open tabs on a computer system is depicted. In various embodiments, method 500 may be performed by a computer system such as computer systems 101 and 201 in FIGS. 1-4. Method 500 is described below using system 100 of FIG. 1 as an example. References to elements in FIG. 1 are included as non-limiting examples.

At block 510, method 500 begins with a computer system executing instructions of a browser extension to perform a search query to identify particular information included within two or more selected tabs of a web browser. For example, computer system 101 may execute instructions of extension 115 to perform search query 140. Computer system 101 may further generate user interface 117a to display tabs 107 that are open in web browser 110 and are available for searching. Via user interface 117a, a user of computer system 101 may select tabs 107a and 107c for performing search query 140. Tabs 107b and 107d, while available for search query 140, are not selected. The selected tabs 107a and 107c may include respective information 125a and 125c that are retrieved from servers 120a and 120c, respectively.

To perform search query 140, method 500 proceeds to block 520a with the computer system searching a first portion of memory storing data for a first selected tab for the particular information. Memory 130, as described above, may be included in computer system 101 or be coupled to and accessible by computer system 101. To generate content for tab 107a, web browser 110 may download information 125a from server 120a and store it in memory 130, where access times for computer system 101 to read memory 130 may be less than access times for computer system 101 to read information 125a from server 120a. In block 520a, computer system 101 may search a portion of memory 130 where information 125a is stored for tab 107a.

Method 500 proceeds to perform search query 140 in block 520b with the computer system searching a second portion of memory that stores data for a second selected tab for the particular information. In a similar fashion as described for block 520a, computer system 101 may search a different portion of memory 130 where information 125c is stored for tab 107c. It is noted that, unlike a Google search in which the World Wide Web may be searched, search query 140 searches through information that has already been downloaded from servers 120a and 120c and stored locally in memory 130. Results that may be available across the web but are not associated with the selected tabs 107a and 107c are not identified by search query 140.

Method 500 continues at block 530 with the computer system aggregating identified information resulting from the search query, including filtering the results into ones of a plurality of categories. As shown in FIG. 1, for example, computer system 101 (using extension 115) may receive identified information from search query 140 and aggregate results from information 125a with results from information 125c. Aggregating the identified information may include computer system 101 pre-processing the identified information to remove extraneous information, such as file sizes, revision histories, last modified dates, and the like. In some embodiments, extension 115 may determine what extraneous information to remove and what to retain based on input from the user of computer system 101, e.g., via user interface 117. One or more filters may be implemented to reduce the aggregated results to those that are of most interest to the user.

At block 540, method 500 proceeds with the computer system generating a user interface for the aggregated information, including an interface to select one of the plurality of categories to display. As depicted in FIG. 1, computer system 101 creates user interface 117b to display results after the aggregating has been completed. User interface 117b includes three selectable categories 118. As depicted, the user selects category 118a.

Method 500, at block 550, continues with the computer system displaying, by the computer system, a subset of the aggregated information related to the selected category. For example, category 118a may be a summary category in which high level information from the filtered results is extracted and displayed with brevity, thereby allowing more results to be displayed on a screen of computer system 101 at one time. Categories 118b and 118c may be different categories (e.g., highlights and insights as described above) in which an increasing amount of information is displayed for each result. As an amount of information for each result is increased, a number of results displayable per page may decrease.

Use of method 500 may reduce a complexity of performing searches across a plurality of open browser tabs. Instead of performing a respective search within each desired tab, a plurality of tabs may be searched concurrently based on a same set of search terms. This reduced complexity, in turn, may improve worker productivity as well as reduce processing time of computing equipment in system 100 by performing searches across the selected tabs concurrently rather than serially.

It is noted that the method of FIG. 5 includes blocks 510-550. Method 500 may end in block 550 or may repeat some or all of blocks 510-550 for a subsequent search. For example, blocks 510-550 may be repeated in response to the user changing one or more search terms in search query 140. Blocks 530-550 may be repeated in response to the user selecting a different category or modifying other filtering parameters. In some cases, method 500 may be performed concurrently with other instances of the method. For example, two or more processors in computer system 101 may each perform a respective instance of method 500 if, for example, the user requests a second search query while a first search query is in progress.

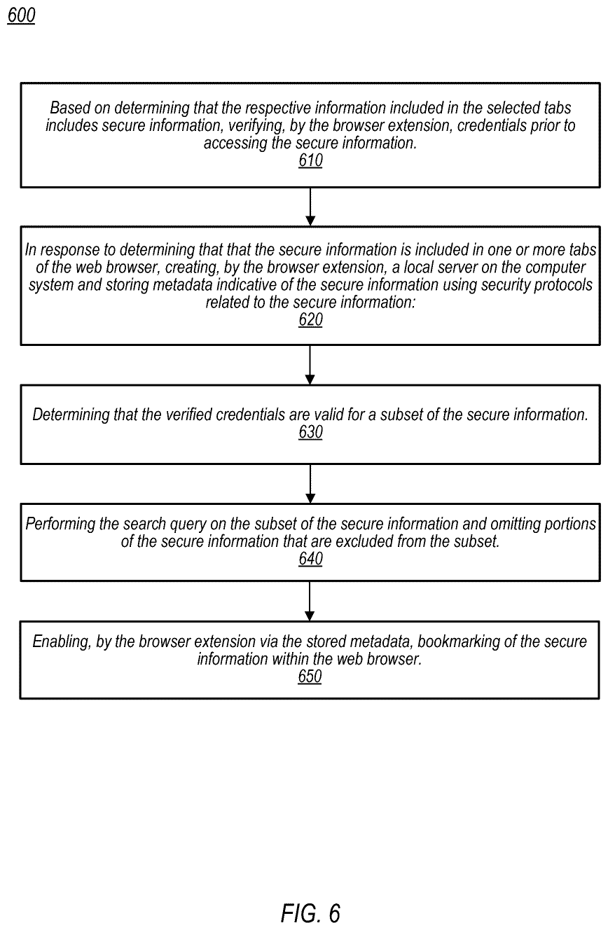

Moving to FIG. 6, a flow diagram of an embodiment of a method for performing a search query that includes a selected tab with secure information is depicted. In a similar manner to method 500, method 600 may be performed by a computer system such as computer systems 101 and/or 201 in FIGS. 1-4. In some embodiments, portions or all of method 600 may correspond to one or more actions that occur, for example, as a part of block 510 in method 500. Method 600 is described below using system 300 in FIG. 3 as an example. References to elements in FIG. 3 are included as non-limiting examples. Operations of method 600 may begin in block 510 of method 500, e.g., after computer system 201 has received indications that tabs 207a and 207b have been selected for inclusion in a search query.

At block 610, method 600 begins with a computer system, based on determining that the respective information included in the selected tabs includes secure information, verifying credentials prior to accessing the secure information. For example, extension 315 may attempt to access secure information 225a on server 220a and receive a prompt for credentials to authorize access. In other embodiments, extension 315 may determine that tab 207a sent credentials to server 220a, or that tab 207a currently includes a security cookie that enables access to server 220a. Any suitable technique for determining that tab 207a includes secure information 225a that requires authorization to access may be utilized. Similar techniques may further be used to determine that tab 207b also includes secure information 225b. After the determination has been made, extension 315 may prompt a user of computer system 201 to enter valid credentials in order to proceed with the search query. Extension 315 may forward received credentials to servers 220a and 220b, respectively, to gain access to secure information 225a and 225b.

Method 600 may continue to block 620 with the computer system, in response to determining that the secure information is included in one or more tabs of the web browser, creating a local server on the computer system and storing metadata indicative of the secure information using security protocols related to the secure information. As depicted in FIG. 3, extension 315 may generate local server 330 for storing secure metadata 335a related to secure information 225a and secure metadata 335b related to secure information 225b. Local server 330 may be created in memory include within computer system 201 or may be created in a memory device that is separate from, but accessible by computer system 201. For example, computer system 201 may be a personal computer for a given user, and as such, may not meet particular security requirements for storing secure metadata 335. In such an embodiment, a memory device that satisfies such security requirements may be used instead of local memory in computer system 201.

Local server 330 may be stored and maintained after a search query that initiated the creation of local server 330 has completed. By saving this information, a subsequent search query may take less time to be performed. In addition, any filters search terms, bookmarks and the like that are associated with secure metadata 335 may be maintained and reused for ease of use and increased efficiency as compared to rebuilding local server 330 for every search query involving any of secure information 225. If a subsequent search query is performed that includes an access to any secure information 225, then extension 315 may prompt the user for credentials to access secure metadata 335.

Method 600 may proceed to block 630 with the computer system determining that the verified credentials are valid for a subset of the secure information. For example, the user, or a colleague of the user, may attempt to perform a search query that includes access to at least a portion of secure information 225. In response to submitting the search query, the current user may be prompted to provide their credentials before the search may begin. The current user's credentials may not have a same level of access as the prior credentials used to generate local server 330, but rather the new credentials may be valid for only a portion of secure information 225.

At block 640, method 600 continues with the computer system performing the search query on the subset of the secure information and omitting portions of the secure information that are excluded from the subset. Based on the determination that the new credentials are valid for only a portion of secure information 225, extension 315 may limit the current search query to returning results from a portion of secure metadata 335, e.g., authorized secure metadata 336a and 336b while omitting unauthorized secure metadata 337a and 337b. In other embodiments, all of secure metadata 335 may be searched and results from both the authorized portions 336 and unauthorized portions 337 may be returned. The current user, however, may not be capable of accessing any of secure information 225 that is associated with results from unauthorized portions 337.

Method 600 may continue at block 650 with the computer system enabling, by the browser extension via the stored metadata, bookmarking of the secure information within the web browser. As described above, a current user may be allowed to bookmark results produced from the search query. For example, bookmark 317a may link to authorized secure metadata 336a in local server 330 or may link to the relevant secure information 225a in server 220a. In some cases, bookmarks 317 to secure metadata 335 in local server 330 may increase an ease of sharing information with colleagues since secure metadata 335 may identify and/or describe the related secure information 225 without actually divulging any secure information.

It is noted that the method of FIG. 6 includes blocks 610-650. Method 600 may end in block 650 or may end in block 640 if no bookmarking is performed. In some cases, some, or all, of the operations may be repeated in response to submission of a subsequent search query. For example, blocks 630-650 may be repeated in response to a resubmission of a same search query at a subsequent point in time. In a similar manner to method 500, different instances of method 600 may be performed concurrently for different search queries. Method 600 may be performed concurrently with (or as a part of) method 500.

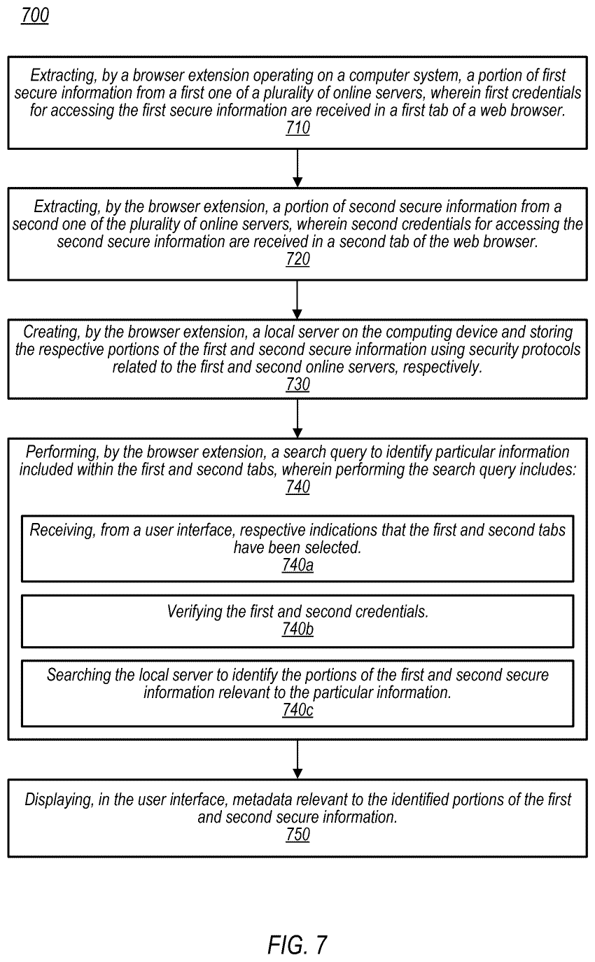

Moving to FIG. 7, a flow diagram of another embodiment of a method for performing a search query that includes a selected tab with secure information is illustrated. In a similar manner to methods 500 and 600, method 700 may be performed by a computer system such as computer systems 101 and 201 in FIGS. 1-4. Method 700 is described below using system 200 in FIG. 2 as an example. References to elements in FIG. 2 are included as non-limiting examples. Operations of method 700 may begin in block 710.

At block 710, method 700 begins with a computer system extracting a portion of first secure information from a first one of a plurality of online servers, wherein first credentials for accessing the first secure information are received in a first tab of a web browser. For example, a user of computer system 201 may use tab 207a of web browser 210 to access secure information 225a that is provided by server 220a, providing credentials 208a in order to gain access to this information. Based on a level of access associated with credentials 208a, portions of secure information 225a that are authorized for access may be downloaded and displayed on a screen of computer system 201 within tab 207a.

Further operation of method 700 may continue in block 720 with the computer system extracting a portion of second secure information from a second one of the plurality of online servers, wherein second credentials for accessing the second secure information are received in a second tab of the web browser. In a similar manner as described in block 710, the user may provide credentials 208b to gain access to at least a portion of secure information 225b in server 220b. Based on a level access afforded to credentials 208b, authorized portions of secure information 225b are downloaded and may be displayed on the screen of computer system 201 within tab 207b.

Method 700 may proceed to block 730 with the computer system creating a local server on the computing device and storing the respective portions of the first and second secure information using security protocols related to the first and second online servers, respectively. Extension 215 has been added to web browser 210 to provide additional features, including determining that credentials 208a and 208b are used to access the respective portions of secure information 225a and 225b. Based on this determination, extension 215 may generate local server 230 in which to store the authorized portions of secure information 225a and 225b. In order to maintain adequate security for the stored portions of secure information 225, similar security protocols, as used by servers 220, may be placed on the portions of secure information 225a and 225b that are stored in local server 230. In some embodiments, secure information 225a in local server 230 may be stored using the same protocols as used by server 220a while secure information 225b in local server 230 may be stored using the same protocols as used by server 220b. In other embodiments, a single security protocol that meets or exceeds security requirements of both servers 220a and 220b may be used.

Method 700 may continue at block 740 with the computer system performing a search query to identify particular information included within the first and second tabs. For example, the user of computer system 201 initiates a search query that includes searching information included in both tabs 207a and 207b. Extension 215 includes a search feature that enables the user to search both tabs 207a and 207b concurrently, using a single search query. In some embodiments, extension 215 may be capable of receiving natural language text for the search query. A machine learning model may then parse the natural language text to generate suitable search terms.

Performing the search query may include, at block 740a, the computer system receiving, from a user interface, respective indications that the first and second tabs have been selected. For example, the user interface may display a list of all currently open tabs in web browser 210 along with an input method for identifying which of the open tabs are to be included in the search query. Performing the search query may also include, at block 740b, verifying the first and second credentials. Extension 215 may, in response to determining that tabs 207a and 207b are included in the search query, prompt the user to enter credentials 208a and 208b in order to access secure information 225 in local server 230. In some embodiments, extension 215 may be capable of using respective cookies associated with tabs 207a and 207b, respectively, that provide local server 230 with suitable indications that credentials 208a and 208b have been validated and the user is authorized to access secure information 225a and 225b. Performing the search query may further include, at block 740c, searching the local server to identify the portions of the first and second secure information relevant to the particular information. After the credentials have been validated and extension 215 has confirmation that the user is authorized to access secure information 225a and 225b stored in local server 230, then extension 215 may perform the search query on the information associated with the selected tabs, including searching for the determined search terms within the information stored in local server 230.

Method 700 proceeds at block 750 with the computer system displaying, in the user interface, metadata relevant to the identified portions of the first and second secure information. For example, extension 215 may generate a user interface on the screen of computer system 201 that displays a summary of results from the search query. Such a summary may include metadata associated with the results, such as a URL link to a matching piece of information and a brief description. For example, a particular matching piece of information may be a section of a document included in secure information 225a. Since such a document is included in secure information, it may not be desirable to include actual text from the document. Accordingly, metadata associated with the document may be displayed instead in which the metadata itself does not include secure information but provides information about the document without revealing any secure information. As previously described, such a user interface for the results of the search query may include options for filtering the displayed results, including for example, options to display various levels of detail for each result.

It is noted that the method of FIG. 7 includes blocks 710-750. Method 700 may end in block 750. In some cases, some, or all, of the operations may be repeated in response to initiation of a subsequent search query. In a similar manner to methods 500 and 600, different instances of method 700 may be performed concurrently to perform different search queries. Method 700 may also be performed concurrently with methods 500 and 600.

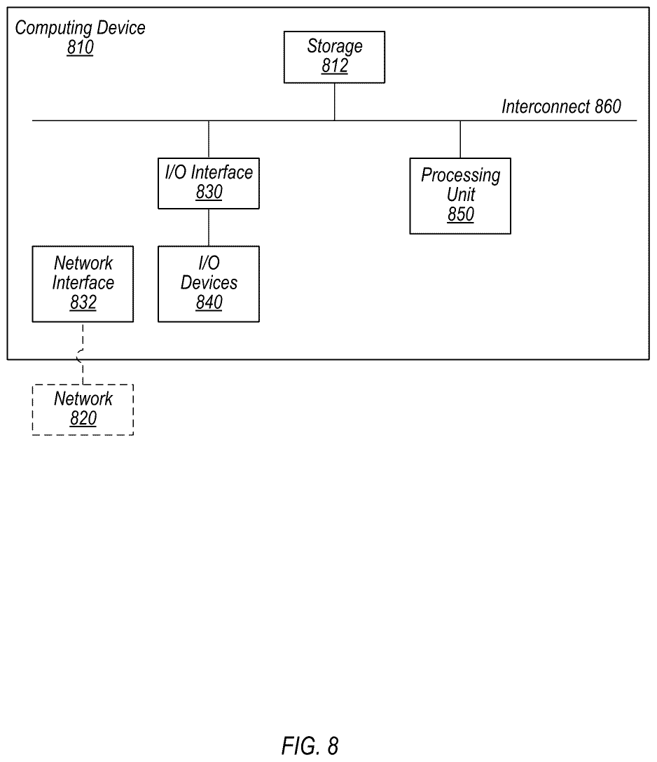

In the descriptions of FIGS. 1-7, various computer systems and online servers have been disclosed. Such systems may be implemented in a variety of fashions. FIG. 8 provides an example of a computer system that may correspond to one or more of the disclosed computer systems and/or servers.

### Example Computing Device

Turning now to FIG. 8, a block diagram of one embodiment of computing device (which may also be referred to as a computer system) 810 is depicted. Computing device 810 may be used to implement various portions of this disclosure including, for example, computer systems 101 and 201, and/or servers 120 and 220 in FIGS. 1-4. Computing device 810 may be any suitable type of device, including, but not limited to, a personal computer system, desktop computer, laptop or notebook computer, mainframe computer system, web server, workstation, or network computer. In some embodiments, computing device 810 may be implemented as a virtual computer system by on or more computers in a database system or server farm. As shown, computing device 810 includes processing unit 850, storage subsystem (storage) 812, and input/output (I/O) interface 830 coupled via an interconnect 860 (e.g., a system bus). I/O interface 830 may be coupled to one or more I/O devices 840. Computing device 810 further includes network interface 832, which may be coupled to network 820 for communicating with, for example, other computing devices.

In various embodiments, processing unit 850 includes one or more processors. In some embodiments, processing unit 850 includes one or more coprocessor units. In some embodiments, multiple instances of processing unit 850 may be coupled to interconnect 860. Processing unit 850 (or each processor within 850) may contain a cache or other form of on-board memory. In some embodiments, processing unit 850 may be implemented as a general-purpose processing unit, and in other embodiments it may be implemented as a special purpose processing unit (e.g., an ASIC). In general, computing device 810 is not limited to any particular type of processing unit or processor subsystem.

Storage subsystem 812 is usable by processing unit 850 (e.g., to store instructions executable by and data used by processing unit 850). Storage subsystem 812 may be implemented by any suitable type of physical memory media, including hard disk storage, floppy disk storage, removable disk storage, flash memory, random access memory (RAM—SRAM, EDO RAM, SDRAM, DDR SDRAM, RDRAM, etc.), ROM (PROM, EEPROM, etc.), and so on. Storage subsystem 812 may consist solely of volatile memory, in one embodiment. Storage subsystem 812 may store program instructions executable by computing device 810 using processing unit 850, including program instructions executable to cause computing device 810 to implement the various techniques disclosed herein.

I/O interface 830 may represent one or more interfaces and may be any of various types of interfaces configured to couple to and communicate with other devices, according to various embodiments. In one embodiment, I/O interface 830 is a bridge chip from a front-side to one or more back-side buses. I/O interface 830 may be coupled to one or more I/O devices 840 via one or more corresponding buses or other interfaces. Examples of I/O devices include storage devices (hard disk, optical drive, removable flash drive, storage array, SAN, or an associated controller), network interface devices, user interface devices or other devices (e.g., graphics, sound, etc.).

Various articles of manufacture that store instructions (and, optionally, data) executable by a computing system to implement techniques disclosed herein are also contemplated. The computing system may execute the instructions using one or more processing elements. The articles of manufacture include non-transitory computer-readable memory media. The contemplated non-transitory computer-readable memory media include portions of a memory subsystem of a computing device as well as storage media or memory media such as magnetic media (e.g., disk) or optical media (e.g., CD, DVD, and related technologies, etc.). The non-transitory computer-readable media may be either volatile or nonvolatile memory.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different elements (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

In this disclosure, various “modules” operable to perform designated functions may be shown in the figures and described in detail. As used herein, a “module” refers to software or hardware that is operable to perform a specified set of operations. A module may refer to a set of software instructions that are executable by a computer system to perform the set of operations. A module may also refer to hardware that is configured to perform the set of operations. A hardware module may constitute general-purpose hardware as well as a non-transitory computer-readable medium that stores program instructions, or specialized hardware such as a customized ASIC.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), functional unit, memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement and such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits or portions thereof may also be custom-designed in a schematic editor and captured into the integrated circuit design along with synthesized circuitry. The integrated circuits may include transistors and other circuit elements (e.g. passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. A method comprising:
executing, by a computer system, instructions of a browser extension to perform a search query to identify particular information included within two or more selected tabs of a web browser, wherein the selected tabs include respective information retrieved from one or more servers, and wherein performing the search query includes:
searching a first portion of memory storing data for a first selected tab for the particular information; and
searching a second portion of the memory storing data for a second selected tab for the particular information;
aggregating, by the computer system, identified information resulting from the search query, including filtering the results into ones of a plurality of categories;
generating, by the computer system, a user interface for the aggregated information, including an interface to select one of the plurality of categories to display; and
displaying, by the computer system, a subset of the aggregated information related to the selected category.

2. The method of claim 1, wherein the respective information included in the selected tabs includes secure information requiring authorization to access, and wherein performing the search query further includes verifying, by the browser extension, credentials prior to accessing the secure information.

3. The method of claim 2, further comprising:
in response to determining that the secure information is included in one or more tabs of the web browser, creating, by the browser extension, a local server on the computer system and storing metadata indicative of the secure information using security protocols related to the secure information.

4. The method of claim 3, further comprising:
enabling, by the browser extension via the stored metadata, bookmarking of the secure information within the web browser.

5. The method of claim 2, further comprising:
determining that the verified credentials are valid for a subset of the secure information; and
performing the search query on the subset of the secure information and omitting portions of the secure information that are excluded from the subset.

6. The method of claim 1, wherein the respective information in the selected tabs includes video files, and wherein performing the search query includes identifying portions of the video file that correspond to the particular information.

7. The method of claim 1, wherein the plurality of categories corresponds to different levels of detail of the identified information, including:
a summary category that includes a least number of details; and
an insights category that includes a greatest number of details.

8. The method of claim 1, wherein aggregating the identified information includes pre-processing the identified information to remove extraneous information.

9. A non-transitory computer-readable medium having instructions stored thereon that are executable by a computing device to perform operations of a browser extension comprising:
performing a search query to identify particular information included within retrieved information associated with two or more selected tabs of a plurality of tabs within a web browser, wherein performing the search query includes:
indicating, via a first user interface, ones of the plurality of tabs that are available to search;
receiving indications of ones of the plurality of tabs that have been selected;
searching the retrieved information corresponding to the selected tabs to identify information relevant to the particular information;
filtering the identified information from the selected tabs into ones of a plurality of categories;
generating a second user interface for the filtered information, including options to select a particular one of the plurality of categories to display; and
displaying, in the second user interface, a subset of the filtered information included in a selected one of the plurality of categories.

10. The non-transitory computer-readable medium of claim 9, wherein the respective information included in the selected tabs includes secure information requiring authorization to access, and wherein the operations for performing the search query further include verifying, by the browser extension, credentials prior to accessing the secure information.

11. The non-transitory computer-readable medium of claim 10, wherein at least two of the selected tabs include respective secure information, and wherein the operations for performing the search query further include verifying, by the browser extension, respective credentials for ones of the at least two selected tabs prior to accessing the respective secure information.

12. The non-transitory computer-readable medium of claim 10, wherein the operations further include:
in response to determining that secure information is included in the selected tabs, creating a local server on the computing device and storing metadata indicative of the secure information using security protocols related to the secure information.

13. The non-transitory computer-readable medium of claim 12, wherein the operations further include:
enabling, via the stored metadata, bookmarking of the secure information within the browser extension.

14. A non-transitory computer-readable medium having instructions stored thereon that are executable by a computing device to perform operations of a browser extension comprising:
extracting a portion of first secure information from a first one of a plurality of online servers, wherein first credentials for accessing the first secure information are received in a first tab of a web browser;
extracting a portion of second secure information from a second one of the plurality of online servers, wherein second credentials for accessing the second secure information are received in a second tab of the web browser;
creating a local server on the computing device and storing the respective portions of the first and second secure information using security protocols related to the first and second online servers, respectively;
performing a search query to identify particular information included within the first and second tabs, wherein performing the search query includes:
receiving, from a user interface, respective indications that the first and second tabs have been selected;
verifying the first and second credentials; and
searching the local server to identify the portions of the first and second secure information relevant to the particular information; and
displaying, in the user interface, metadata relevant to the identified portions of the first and second secure information.

15. The non-transitory computer-readable medium of claim 14, wherein the respective portions of the first and second secure information:
include links to the first and second secure information in the first and second online servers, respectively; and
exclude restricted portions of the first and second secure information.

16. The non-transitory computer-readable medium of claim 14, wherein the operations further include:
organizing, within the local server based on indications from the user interface, the respective portions of the first and second secure information; and
storing, within the local server, the organized portions of the first and second secure information for subsequent search queries.

17. The non-transitory computer-readable medium of claim 16, wherein the operations further include bookmarking, using the organized portions, a particular item in the identified portions of the first and second secure information.

18. The non-transitory computer-readable medium of claim 14, wherein the operations further include:
aggregating the identified portions of the first secure information with the identified portions of the second secure information; and
filtering the aggregated portions into ones of a plurality of categories.

19. The non-transitory computer-readable medium of claim 18, wherein to filter the aggregated portions, the operations further include:
receiving, from the user interface, one or more filtering parameters; and
filtering the aggregated portions based on the one or more filtering parameters.

20. The non-transitory computer-readable medium of claim 18, wherein the operations further include:
receiving, from the user interface, an indication of a detail level for displaying information; and
using the indicated detail level to determine a type of metadata to display for ones of the identified portions.
